(19) United States
(12) Patent Application Publication
(10) Pub. No.: US 2009/0059364 A1
(43) Pub. Date: Mar. 5, 2009

(54) SYSTEMS AND METHODS FOR ELECTRONIC AND VIRTUAL OCULAR DEVICES

(75) Inventors: Lawrence G. Brown, Towson, MD (US); Yuval S. Boger, Baltimore, MD (US)

Correspondence Address: KASHA LAW LLC, 10310 POTOMAC CORNER DRIVE, ROCKVILLE, MD, 20850, US

(73) Assignee: Sensics Inc.

(21) Appl. No.: 12/263,711

(22) Filed: Nov. 3, 2008

Related U.S. Application Data
(63) Continuation-in-part of application No. 11/934,373, filed on Nov. 2, 2007.
(60) Provisional application No. 60/856,021, filed on Nov. 2, 2006.
(60) Provisional application No. 60/944,853, filed on Jun. 19, 2007.
(60) Provisional application No. 60/984,473, filed on Nov. 1, 2007.

(51) Int. Cl. G02B 23/00; G02B 27/22

(52) U.S. Cl. 359/421; 359/466

(57) ABSTRACT

An ocular device is be used to magnify virtual and real scenes in a binocular or monocular configuration. A plurality of lenses is positioned as though each of the lenses is tangent to a surface of a first sphere having a center that is located substantially at a center of rotation of an eye of a user. A plurality of displays is positioned as though each of the displays is tangent to a surface of a second sphere having a radius larger than the first sphere's radius and having a center that is located at a center of rotation of the eye. Each of the displays corresponds to at least one of the lenses, and is imaged by the corresponding lens. A processor displays an image to the user using the plurality of displays. An input device allows the user to adjust a magnification of the image.

### CROSS-REFERENCE TO RELATED APPLICATION

This application is a continuation-in-part application of U.S. patent application Ser. No. 11/934,373, filed Nov. 2, 2007 (the “'373 application”), which claims the benefit of U.S. Provisional Patent Application Ser. No. 60/856,021 filed Nov. 2, 2006 and U.S. Provisional Patent Application Ser. No. 60/944,853 filed Jun. 19, 2007. This application also claims the benefit of U.S. Provisional Patent Application No. 60/984,473 filed Nov. 1, 2007. All of the above mentioned applications are incorporated by reference herein in their entireties.

### BACKGROUND OF THE INVENTION

1. Field of the Invention

Embodiments of the present invention relate to electronic and virtual binoculars. More particularly, embodiments of the present invention relate to systems and methods for displaying images in electronic and virtual binoculars and capturing images for electronic binoculars.

2. Background Information

Binoculars are used to magnify a user's vision, to permit an apparently closer view of the object or scene of interest. A pair of conventional binoculars is basically two small refracting telescopes held together by a frame that, by definition, produce a stereoscopic or three-dimensional view. Each refracting telescope has an optical path defined through an objective lens, a pair of prisms, and an eye piece. The diameter of the objective lens determines the light-gathering power. The two objective lenses are further apart than the eyepieces, which enhances stereoscopic vision. Functioning as a magnifier, the eyepiece forms a large virtual image that becomes the object for the eye itself and thus forms the final image on the retina.

Electronics have been added to conventional binoculars to allow images to be captured, recorded, or displayed digitally. Binoculars incorporating such electronics have been called electronic or digital binoculars. In U.S. Pat. No. 5,581,399, it was suggested that each telescope in a pair of binoculars be provided with an image sensor, a first optical system, a second optical system and a display so that the binoculars could selectively view optically projected images and electronically reproduced images that are stored by the binoculars. The display was a single element type liquid crystal display (LCD), which appears transparent when optically projected images are viewed. When electronically reproduced images were to be viewed, a back light was pivoted behind the display from the eyepiece side. While such binoculars offer the advantage of limited storage and playback of images, they rely upon mechanical components that are subject to wear and failure. Further, because the display is located in the optical path, even though it appears transparent when the optical path is being used, the image quality is degraded, and brightness is lost, due to placement of the display in the optical path.

In U.S. Pat. No. 7,061,674 a pair of electronic binoculars is described where the display was decoupled from the optical system. The electronic binoculars included an imaging unit, a display unit, and an image-signal processing unit. The imaging unit had an optical system such as a photographing optical system, and an imaging device for converting an optical image, obtained by the optical system, to an electrical signal. The imaging unit included one or two optical systems. The image-signal processing unit converted the electrical signal to an image signal. The image signal was transmitted to the display unit, so that an image could be displayed by the display unit. The display unit included right and left display elements and lenses. The display elements were single LCDs. Since the display unit was decoupled from the imaging unit, there was less reliance on mechanical components and the image quality was improved. However, the image resolution was still limited by the resolution of the display elements of the display unit.

Virtual binoculars have been developed to simulate the function of binoculars in a virtual world. Virtual binoculars differ from optical binoculars and electronic binoculars in that virtual binoculars do not require optical input or real world image input. The images shown in virtual binoculars are computer generated images. Virtual binoculars generally include virtual reality displays enclosed in a housing with a form factor consistent with conventional optical binoculars. Virtual binoculars can also include a motion sensing device. The displays used in virtual binoculars are typically single element displays similar to those used in electronic binoculars. As a result, the image quality of virtual binoculars is also limited by the resolution of the display elements.

In view of the foregoing, it can be appreciated that a substantial need exists for systems and methods that can improve the resolution of the image displayed in electronic and virtual binoculars.

### BRIEF DESCRIPTION OF THE DRAWINGS AND EXHIBITS

FIG. 1 is a schematic diagram of electronic binoculars, in accordance with an embodiment of the present invention.

FIG. 2 is a schematic diagram of virtual binoculars, in accordance with an embodiment of the present invention.

FIG. 3 is a flowchart showing a method for presenting a telescopic image to a user, in accordance with an embodiment of the present invention.

Before one or more embodiments of the invention are described in detail, one skilled in the art will appreciate that the invention is not limited in its application to the details of construction, the arrangements of components, and the arrangement of steps set forth in the following detailed description or illustrated in the drawings. The invention is capable of other embodiments and of being practiced or being carried out in various ways. Also, it is to be understood that the phraseology and terminology used herein is for the purpose of description and should not be regarded as limiting.

### DETAILED DESCRIPTION OF THE INVENTION

The '373 application describes a head-mounted display (HMD) with an upgradeable field of view. The HMD includes an existing lens, an existing display, an added lens, and an added display. The existing display is imaged by the existing lens and the added display is imaged by the added lens. The existing lens and the existing display are installed in HMD at the time of manufacture of the HMD. The added lens and the added display are installed in the HMD at a time later than the time of manufacture. The existing lens and the added lens are positioned relative to one another as though each of the lenses is tangent to a surface of a first sphere having a center that is located substantially at a center of rotation of an eye of a user. The existing display and the added display are positioned relative to one another as though each of the displays is tangent to a surface of a second sphere having a radius larger than the first sphere's radius and having a center that is located at the center of rotation of the eye. The added lens and the added display upgrade the field of view of the HMD.

The field of view of the HMD described in the '373 application can also be extended. An added lens is positioned in the HMD relative to an existing lens as though each of the lenses is tangent to a surface of a first sphere having a center that is located substantially at a center of rotation of an eye of a user of the HMD. An added display is positioned in the HMD relative to an existing display as though each of the displays is tangent to a surface of a second sphere having a radius larger than the first sphere's radius and having a center that is located at the center of rotation of the eye. The added lens and the added display extend the field of view of the HMD. A first image shown on the existing display is aligned with a second image shown on the added display using a processor and an input device. The processor is connected to the HMD and the input device is connected to the processor. Results of the alignment are stored in a memory connected to the processor.

The key attributes of the displays of an HMD include field of view (FOV), resolution, weight, eye relief, exit pupil, luminance, and focus. While the relative importance of each of these parameters varies for each user, FOV and resolution are generally the first two parameters a user will note when evaluating an HMD.

Since electronic and virtual binoculars use the same type of displays as HMDs, these same key attributes are also important for electronic and virtual binoculars. However, because the FOV is limited in conventional binoculars, a larger FOV is not as important in electronic and virtual binoculars as it is in HMDs. The most important attribute for the displays of electronic and virtual binoculars is, therefore, resolution.

Generally, with single element displays there is a tradeoff between resolution and FOV. If the resolution is increased, the FOV will be decreased. Similarly, if the FOV is increased the resolution will be decreased. The resolution affected by the FOV is not the resolution of the display, which is measured in pixels per some unit of length. Rather the resolution affected by the FOV is the angular resolution, which is sometimes called the visual acuity. The angular resolution is measured in pixels per degree. Increasing the FOV, for example, decreases the angular resolution because increasing the magnification decreases the number of pixels per degree. Similarly, decreasing the FOV increases the angular resolution, because decreasing the magnification increases the number of pixels per degree.

One embodiment of the present invention is a display system for electronic and virtual binoculars that provides greater angular resolution without sacrificing the FOV. This system uses more than one miniature display per eye in a display array to produce greater resolution. The display array coupled with a lens array creates an image that appears as one continuous visual field to a user.

The display array and lens array of this system are described in U.S. Pat. No. 6,529,331 (“the '331 patent”), which is herein incorporated by reference. The system includes an optical system in which the video displays and corresponding lenses are positioned tangent to hemispheres with centers located at the centers of rotation of a user's eyes. Centering the optical system on the center of rotation of the eye is a feature of the system that allows it to achieve both high fidelity visual resolution and a full field of view without compromising visual resolution.

The system uses an array of lens facets that are positioned tangent to the surface of a sphere. The center of the sphere is located at an approximation of the “center of rotation” of a user's eye. Although there is no true center of eye rotation, one can be approximated. Vertical eye movements rotate about a point approximately 12 mm posterior to the cornea and horizontal eye movements rotate about a point approximately 15 mm posterior to the cornea. Thus, the average center of rotation is 13.5 mm posterior to the cornea.

The system also uses a multi-panel video wall design for the video display of the electronic binoculars. Each lens facet images a miniature flat panel display, which is positioned at optical infinity or is adjustably positioned relative to the lens facet. The flat panel displays are centered on the optical axes of the lens facets. They are also tangent to a second larger radius sphere with its center also located at the center of rotation of the eye.

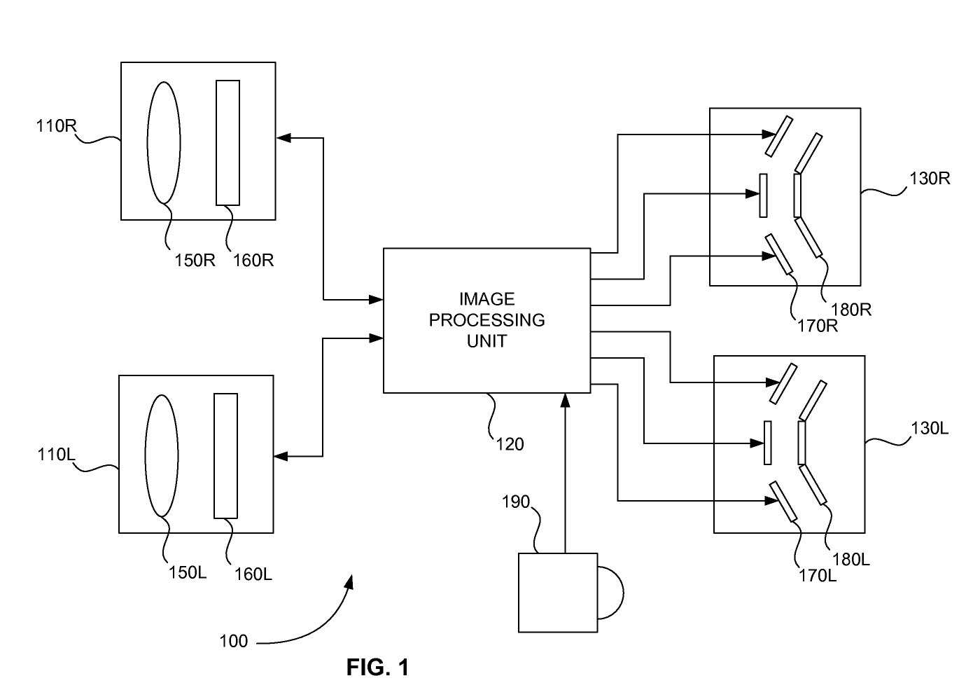

FIG. 1 is a schematic diagram of electronic binoculars 100, in accordance with an embodiment of the present invention. Electronic binoculars 100 includes right imaging unit 110R, left imaging unit 110L, image processing unit 120, right display unit 130R, left display unit 130L, and input device 190.

Right imaging unit 110R and left imaging unit 110L capture the optical image of an object or scene and convert it to an electrical signal. Right imaging unit 110R includes objective lens 150R and image detector 160R. Image detector 160R is, for example, a charge coupled device (CCD). Left imaging unit 110L includes objective lens 150L and image detector 160L. Image detector 160L is, for example, a CCD. Electronic binoculars 100 is shown in FIG. 1 with two imaging units. In various embodiments, electronic binoculars 100 includes one imaging unit. In various embodiments, electronic binoculars 100 includes more than two imaging units.

Image processing unit 120 receives an electrical signal from right imaging unit 110R and left imaging unit 110L. Image processing unit 120 can be, but is not limited to, a digital signal processor, a microprocessor, or a computer. Image processing unit 120 converts the received electrical signals to image signals.

Right display unit 130R and left display unit 130L receive image signals from image processing unit 120. Right display unit 130R includes display element array 170R and lens array 180R. Lens array 180R includes a plurality of lenses positioned relative to one another as though each of the lenses is tangent to a surface of a first sphere having a center that is located substantially at a center of rotation of the eye. A lens of lens array 180R is a convex aspheric lens, for example. Display element array 170R includes a plurality of displays positioned relative to one another as though each of the displays is tangent to a surface of a second sphere having a radius larger than the first sphere's radius and having a center that is located at the center of rotation of the eye. Each of the display elements of display element array 170R corresponds to at least one of the lenses of lens array 180R, and is imaged by the corresponding lens. In various embodiments, display element array 170R is a flexible display.

Left display unit 130L includes display element array 170L and lens array 180L. Lens array 180L includes a plurality of lenses positioned relative to one another as though each of the lenses is tangent to a surface of a first sphere having a center that is located substantially at a center of rotation of the eye. A lens of lens array 180L is a convex aspheric lens, for example. Display element array 170L includes a plurality of displays positioned relative to one another as though each of the displays is tangent to a surface of a second sphere having a radius larger than the first sphere's radius and having a center that is located at the center of rotation of the eye. Each of the display elements of display element array 170L corresponds to at least one of the lenses of lens array 180L, and is imaged by the corresponding lens. In various embodiments, display element array 170L is a flexible display.

Electronic binoculars 100 include input device 190. Input device 190 allows a user to adjust the magnification of the image seen in right display unit 130R and left display unit 130L. The magnification of the image seen in right display unit 130R and left display unit 130L can be adjusted by increasing or decreasing the size of the image using image processing unit 120, for example. As shown in FIG. 1, input device 190 is connected to image processing unit 120. Input device 190 is shown as an adjustable wheel in FIG. 1, but can include any input device capable of continuously varying the level of magnification.

In various embodiments, input device 190 can be used to adjust the magnification of the optical images captured by imaging units 110R and 110L. Input device 190 can, for example, adjust objective lenses 150R and 150L to adjust the magnification of the optical images that are captured. Input device 190 can be connected to imaging units 110R and 110L through image processing unit 120. Also, input device 190 can be connected directly to imaging units 110R and 110L.

Right display unit 130R and left display unit 130L are show in FIG. 1 as being decoupled from the optical path of imaging units 110R and 110L. In various embodiments, right display unit 130R is placed in the optical path of right imaging unit 110R, and left display unit 130L is placed in the optical path of left imaging unit 110L. Right display unit 130R and left display unit 130L are then transparent to optical images projected through them. Right display unit 130R and left display unit 130L can, therefore, be used to project an image on an optical image. Such projection of a display image on an optical image is called augmented reality.

In various embodiments, electronic binoculars 100 include a motion sensor (not shown). A motion sensor is used to properly align any artificial or project image on right display unit 130R and left display unit 130L.

In various embodiments, right imaging unit 110R and left imaging unit 110L include a tiled camera array that can capture images from a complete hemisphere. Each tiled camera array can include two or more CCD cameras with custom optics, for example. In various embodiments, each tiled camera array includes two or more complementary metal oxide semiconductor (CMOS) image sensors. Each tiled camera array forms the shape of a hemisphere. Camera elements are placed inside the hemisphere looking out through the lens array, for example. The nodal points of all lens panels then coincide at the center of a sphere, and mirrors are used to allow all the cameras to fit. In various embodiments, camera elements are placed outside the lens hemisphere and positioned in a second concentric hemisphere having a larger radius than the radius of the lens hemisphere. The camera elements then look in and through the lens hemisphere.

Each tiled camera array need not correspond one-to-one with the tiled array of displays in right display unit 130R and left display unit 130L. In a virtual space, a three-dimensional tiled hemisphere with a rectangular or trapezoidal tile for each camera in the tiled camera array is created. Each camera image is then texture mapped onto the corresponding tile in the virtual array. This produces conceptually a virtual hemisphere or dome structure with the texture mapped video on the inside of the structure. An array of virtual cameras, where each virtual camera corresponds to an element of right display element array 170R or left display element array 170L, for example, is placed inside the virtual hemisphere. This allows for video from each tiled camera array to be displayed in its corresponding right display unit 130R or left display unit 130L.

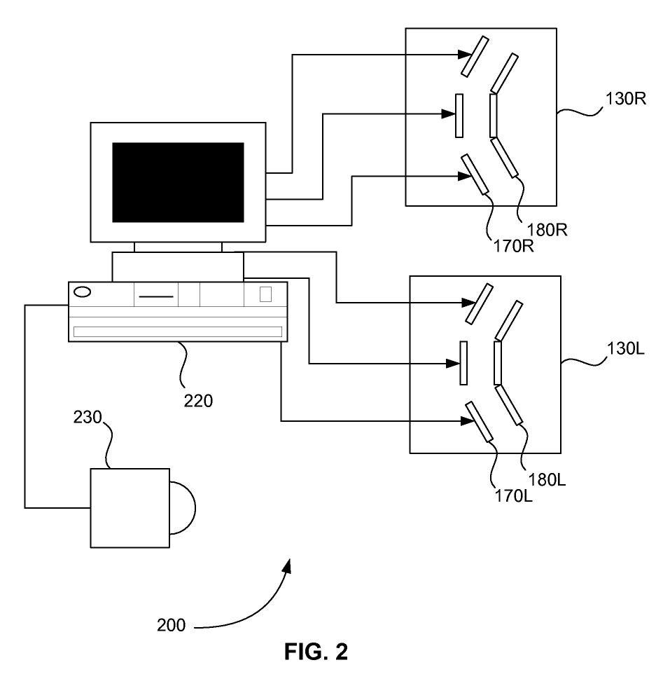

FIG. 2 is a schematic diagram of virtual binoculars 200, in accordance with an embodiment of the present invention. Virtual binoculars 200 includes right display unit 130R, left display unit 130L, processor 220, and input device 230. Processor 220 is used to create or process images displayed on right display unit 130R and left display unit 130L. Processor 220 is any processor capable of creating, processing, sending, and receiving images and can be, but is not limited to, a computer, a microprocessor, a digital signal processor, or an application specific integrated circuit. Processor 220 generates an image to be displayed in right display unit 130R and left display unit 130L, for example. In various embodiments, processor 220 reads an image from a memory and transmits the image to right display unit 130R and left display unit 130L.

Right display unit 130R and left display unit 130L receive image signals from processor 220. Right display unit 130R and left display unit 130L provide a stereoscopic view of an image to a user of virtual binoculars 200, for example. Right display unit 130R includes display element array 170R and lens array 180R. Lens array 180R includes a plurality of lenses positioned relative to one another as though each of the lenses is tangent to a surface of a first sphere having a center that is located substantially at a center of rotation of the eye. A lens of lens array 180R is a convex aspheric lens, for example. Display element array 170R includes a plurality of displays positioned relative to one another as though each of the displays is tangent to a surface of a second sphere having a radius larger than the first sphere's radius and having a center that is located at the center of rotation of the eye. Each of the display elements of display element array 170R corresponds to at least one of the lenses of lens array 180R, and is imaged by the corresponding lens. In various embodiments, display element array 170R is a flexible display.

Left display unit 130L includes display element array 170L and lens array 180L. Lens array 180L includes a plurality of lenses positioned relative to one another as though each of the lenses is tangent to a surface of a first sphere having a center that is located substantially at a center of rotation of the eye. A lens of lens array 180L is a convex aspheric lens, for example. Display element array 170L includes a plurality of displays positioned relative to one another as though each of the displays is tangent to a surface of a second sphere having a radius larger than the first sphere's radius and having a center that is located at the center of rotation of the eye. Each of the display elements of display element array 170L corresponds to at least one of the lenses of lens array 180L, and is imaged by the corresponding lens. In various embodiments, display element array 170L is a flexible display.

Virtual binoculars 200 include input device 230. Input device 230 allows a user to adjust the magnification of the image seen in right display unit 130R and left display unit 130L. The magnification of the image seen in right display unit 130R and left display unit 130L can be adjusted by increasing or decreasing the size of the image using processor 220, for example. As shown in FIG. 2, input device 230 is connected to processor 220. Input device 230 is shown as an adjustable wheel in FIG. 2, but can include any input device capable of continuously varying the level of magnification.

In various embodiments, virtual binoculars 200 includes a motion sensor (not shown). A motion sensor is used to properly align a virtual image on right display unit 130R and left display unit 130L as virtual binoculars 200 are moved. The motion sensor also communicates with processor 220, for example.

In various embodiments, a tiled display array and a tiled camera array is included in a monocular device such as an electronic telescope. In various embodiments, a tiled display array is included in a monocular device such as a virtual telescope or virtual monocular device.

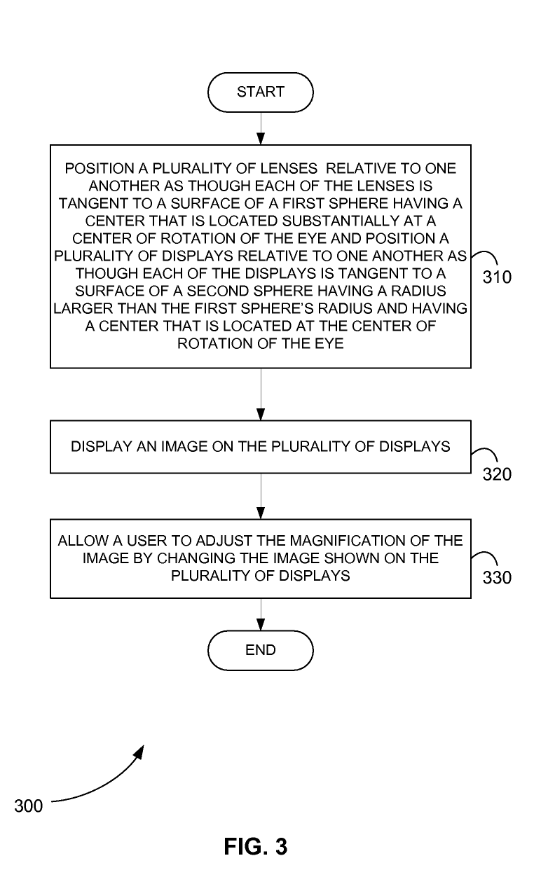

FIG. 3 is a flowchart showing a method 300 for presenting a telescopic image to a user, in accordance with an embodiment of the present invention.

In step 310 of method 300, a plurality of lenses are positioned relative to one another as though each of the lenses is tangent to a surface of a first sphere having a center that is located substantially at a center of rotation of the eye and a plurality of displays are positioned relative to one another as though each of the displays is tangent to a surface of a second sphere having a radius larger than the first sphere's radius and having a center that is located at the center of rotation of the eye.

In step 320, an image is displayed on the plurality of displays. For example, a portion of the image is displayed on each of the plurality of displays. The image displayed on the plurality of displays is a virtual image generated by a processor, for example. In various embodiments, the image displayed on the plurality of displays is an optical image of a real scene received from an imaging unit.

In step 330, a user is allowed to adjust a magnification of the image by changing the image shown on the plurality of displays. For example, input is received from an input device and the size of the image displayed on the plurality of displays is increased in response to the input. In various embodiments, input is received from an input device and the size of the image displayed on the plurality of displays is decreased in response to the input.

In the foregoing detailed description, systems and methods in accordance with embodiments of the present invention have been described with reference to specific exemplary embodiments. Accordingly, the present specification and figures are to be regarded as illustrative rather than restrictive. The scope of the invention is to be further understood by the numbered examples appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

We claim:

1. Virtual binoculars, comprising:
a plurality of first lenses positioned relative to one another as though each of the first lenses is tangent to a surface of a first sphere having a center that is located substantially at a center of rotation of a first eye of a user of the virtual binoculars and a plurality of first displays positioned relative to one another as though each of the first displays is tangent to a surface of a second sphere having a radius larger than the first sphere's radius and having a center that is located at a center of rotation of the first eye, wherein each of the first displays corresponds to at least one of the first lenses, and is imaged by the corresponding first lens;
a plurality of second lenses positioned relative to one another as though each of the second lenses is tangent to a surface of a third sphere having a center that is located substantially at a center of rotation of a second eye of the user and a plurality of second displays positioned relative to one another as though each of the second displays is tangent to a surface of a fourth sphere having a radius larger than the third sphere's radius and having a center that is located at a center of rotation of the second eye, wherein each of the second displays corresponds to at least one of the second lenses, and is imaged by the corresponding second lens;
a processor connected to the plurality of first displays and the plurality of second displays that displays an image to the user using the plurality of first displays and the plurality of second displays; and
an input device connected to the processor that allows the user to adjust a magnification of the image.

2. The virtual binoculars of claim 1, wherein a display of the plurality of first displays comprises a flexible display and a display of the plurality of second displays comprises a flexible display.

3. The virtual binoculars of claim 1, wherein a lens of the plurality of first lenses comprises a convex aspheric lens and a lens of the plurality of second lenses comprises a convex aspheric lens.

4. The virtual binoculars of claim 1, wherein the plurality of first displays and the plurality of second displays provide a stereoscopic view of the image to the user.

5. The virtual binoculars of claim 1, wherein the processor generates the image.

6. The virtual binoculars of claim 1, wherein the processor reads the image from a memory.

7. The virtual binoculars of claim 1, wherein the processor processes the image to adjust the magnification perceived by the user in response to input received from the input device.

8. The virtual binoculars of claim 1, further comprising a first imaging unit connected to the processor that captures a first optical image of a scene and a second imaging unit connected to the processor that captures a second optical image of the scene, wherein the processor displays the first optical image on the plurality of first displays and the processor displays the second optical image on the plurality of second displays to display the image to the user.

9. The virtual binoculars of claim 8, wherein the input device is connected to the first imaging unit and the second imaging unit and the input device affects the magnification of the first optical image and the second optical image.

10. A virtual monocular device, comprising:
a plurality of lenses positioned relative to one another as though each of the lenses is tangent to a surface of a first sphere having a center that is located substantially at a center of rotation of an eye of a user of the virtual monocular device and a plurality of displays positioned relative to one another as though each of the displays is tangent to a surface of a second sphere having a radius larger than the first sphere's radius and having a center that is located at a center of rotation of the eye, wherein each of the displays corresponds to at least one of the lenses, and is imaged by the corresponding lens;
a processor connected to the plurality of displays that displays an image to the user using the plurality of displays; and
an input device connected to the processor that allows the user to adjust a magnification of the image.

11. The virtual monocular device of claim 10, wherein a display of the plurality of displays comprises a flexible display.

12. The virtual monocular device of claim 10, wherein a lens of the plurality of lenses comprises a convex aspheric lens.

13. The virtual monocular device of claim 10, wherein the processor generates the image.

14. The virtual monocular device of claim 10, wherein the processor reads the image from a memory.

15. The virtual monocular device of claim 10, wherein the processor processes the image to adjust the magnification perceived by the user in response to input received from the input device.

16. A method for presenting a telescopic image to a user, comprising:
positioning a plurality of lenses relative to one another as though each of the lenses is tangent to a surface of a first sphere having a center that is located substantially at a center of rotation of the eye and positioning a plurality of displays relative to one another as though each of the displays is tangent to a surface of a second sphere having a radius larger than the first sphere's radius and having a center that is located at the center of rotation of the eye;
displaying an image on the plurality of displays; and
allowing a user to adjust a magnification of the image by changing the image shown on the plurality of displays.

17. The method of claim 16, wherein displaying the image on the plurality of displays comprises displaying a portion of the image on each of the plurality of displays.

18. The method of claim 16, wherein allowing the user to adjust the magnification of the image by changing the image shown on the plurality of displays comprises receiving input from an input device and increasing the size of the image displayed on the plurality of displays in response to the input.

19. The method of claim 16, wherein allowing the user to adjust the magnification of the image by changing the image shown on the plurality of displays comprises receiving input from an input device and decreasing the size of the image displayed on the plurality of displays in response to the input.

20. The method of claim 16, further comprising receiving the image from an imaging unit.
